(19) United States
(12) Patent Application Publication
(10) Pub. No.: US 2001/0009251 A1
(43) Pub. Date: Jul. 26, 2001

(54) Laser machining apparatus

(75) Inventors: Noriyuki Sekizawa, Hiratsuka-shi (JP); Yoshiyuki Niwatsukino, Hiratsuka-shi (JP); Kazuaki Sajiki, Hiratsuka-shi (JP); Aki Tabata, Isehara-shi (JP)

Correspondence Address: ARMSTRONG, WESTERMAN, HATTORI,, McLELAND & NAUGTON, 1725 K Street, N.W., Suite 1000, Washington, DC, 20006, US

(73) Assignee: KOMATSU LTD., Tokyo (JP)

(21) Appl. No.: 09/757,487

(22) Filed: Jan. 11, 2001

(30) Foreign Application Priority Data
Jan. 20, 2000 (JP) 2000-12325
Aug. 28, 2000 (JP) 2000257169

(51) Int. Cl. B23K 26/06; B23K 26/067

(52) U.S. Cl. 219/121.73

(57) ABSTRACT

The invention provides a laser machining apparatus which can effectively machine a fine portion. Accordingly, in a laser machining apparatus which irradiates laser beams (11) onto a subject to be machined (37) so as to perform a machining, there are provided an injection locking type ultraviolet rays laser apparatus (1) having an unstable resonator (45, 46), a condenser array (29) having a plurality of condensers (28) arranged one to one in correspondence to an arrangement of machining positions (98) of the subject to be machined (37), and an intensity distribution converting optical part (25) for converting an intensity distribution of the laser beams (11).

### FIELD OF THE INVENTION

The present invention relates to a laser machining apparatus which irradiates laser beams and perform a precision machining of a subject to be machined.

### BACKGROUND OF THE INVENTION

Conventionally, there has been known a laser machining apparatus which irradiates laser beams and precisely machines a subject to be machined, and the apparatus is shown, for example, in Japanese Patent Publication 47-45657 (this is called as a first prior art) and Unexamined Japanese Patent Publication No. 4-356392 (this is called as a second prior art).

FIGS. 25 and 26 respectively show the laser machining apparatuses disclosed in the first and second prior arts, and a description will be given below of the prior arts with reference to these drawings. In this case, the prior arts are described only with respect to a piercing process, however, in the following description, the machining includes various kinds of treatments such as an annealing, an etching, a doping or the like in addition to the piercing process.

In accordance with FIG. 25, laser beams 11 oscillated from a laser apparatus 51 is condensed by a condensing lens 52 and passes through a pin hole 54 provided in a shading plate 53, and a wave front is leveled. The laser beams 11 expanding after passing through the pin hole 54 are condensed by a lens 55 and condensed on a subject to be machined 57 by a plurality of objective lens 56 so as to weld fine welding points 58.

Further, in accordance with FIG. 26, the laser beams 11 constituted by a plane wave are irradiated on a mask 60 provided with a Fresnel zone plate 61 (or a micro lens), and the laser beams 11 are condensed by the mask 60, thereby piercing the subject to be machined 57 such as a printed circuit board or the like.

However, each of the prior arts mentioned above has the following problems.

That is, in accordance with the first prior art, the wave front is leveled by condensing the laser beams 11 onto the pin hole 54 by the condensing lens 52, and a condensing characteristic of the laser beams 11 is improved. At this time, in addition that a lot of process and labor is required for positioning a condensing point of the laser beams 11 and the pin hole 54, there is a case that the wave front is destroyed and the condensing characteristic is reduced when the position of the condensing point is shifted from the pin hole 54, and the extreme case is that the pin hole 54 burns.

Further, since the laser beams 11 condensed by the condensing lens 52 are condensed by the objective lens 56, the condensing characteristic of the laser beams 11 is deteriorated and a spot diameter of the laser beams 11 at the condensed position is increased in comparison with the case that the parallel laser beams 11 are condensed by the objective lens 56. Accordingly, it is hard to perform a fine machining even in the case that it is possible to perform a machining such as a welding or the like.

In accordance with the second prior art, the laser beams 11 constituted by the plane wave are irradiated onto the mask 60. It is well known that when the wave front of the laser beams 11 is the plane wave, the condensing characteristic of the laser beam 11 is improved and the fine machining can be performed, however, there is not described particular means for making the wave front of the laser beams 11 the plane wave.

Further, in the second prior art, a wavelength of the beam is exemplified as 248 nm, and an excimer laser and a mercury vapor lamp are supposed to be a light source, however, the excimer laser and the mercury vapor lamp is hard to form the plane wave and have a low light coherent characteristic and a low condensing characteristic. In particular, since the laser beams 11 emitted from a stable type resonator which is popular as a resonator of the excimer laser has a large diverging angle, the laser beam 11 has a low parallel characteristic. Accordingly, it is hard to condense the beams onto a small spot and it is hard to finely machine.

The laser beams 11 emitted from the excimer laser has an uneven intensity distribution and has a greater energy density in a center portion thereof. When irradiating the laser beams 11 onto the mask 60, only the center portion having a greater energy density is early machined, for example, in the case of piercing, so that an excessive energy is input to the center portion until the machining of the peripheral portion is finished, whereby an accuracy of the machining is reduced. That is, it is hard to perform an even piercing process all around the surface of the subject to be machined 57.

Further, in the case of performing the annealing, there is also generated an uneven irradiation on the subject to be machined 57 due to an unevenness of the intensity distribution of the laser beam 11, so that it is hard to machine a whole of the subject to be machined 57 in accordance with a proper irradiating condition. Accordingly, there is partly generated an inferior machined portion.

On the other hand, there has been conventionally known a technique of inputting the laser beams 11 to a fly eye lens or the like so as to make an energy density even and irradiating the laser beams onto the mask 60. However, in accordance with the conventional fly eye lens, it is possible to obtain the even intensity distribution, but the laser beams 11 is emitted from the fly eye lens in a plurality of different directions. Accordingly, it is hard to obtain the parallel beams having the aligned wave front, and it is hard to finely machine due to a reduction of the condensing characteristic.

Further, in accordance with the second prior art, an interval of the holes to be machined is limited by a diameter of the Fresnel zone plate 61, for example, the interval between the holes is recommended to be set to 509 μm or more. That is, in the case of making the interval between the holes smaller than the Fresnel zone plate 61 so as to machine, it is necessary to perform plural times of machining by scanning the mask 60 or the like, and a lot of process and labor are required.

Further, in the printed circuit board or the like, the holes having different diameters to be machined are frequently formed in correspondence to parts to be attached. However, none of the first and second prior arts describe a technique for machining the holes having the different diameters to be machined at one time, and it is necessary to replace the mask 60 and the objective lens 56 in correspondence to the hole having the same diameter to be machined so as to machine, so that a lot of process and labor are required for machining.

Further, FIG. 27 shows a laser machining apparatus 15 in accordance with a third prior art, which performs a machining such as an annealing, an etching or the like due to an irradiation of a laser beam. Conventionally, the laser beams 11 oscillated from the laser apparatus 1 are expanded to have a large area by a lens 99 so as to be irradiated onto the subject to be machined 57 in the bundle. Otherwise, although an illustration is omitted, the laser beams 11 are irradiated in a linearly expanded manner so as to scan the subject to be machined 57.

However, for example, in the case of forming a polycrystalline silicon thin film for a liquid crystal display on a substrate, an area to be machined 98 on which the laser beams 11 are required to be irradiated so as to perform the annealing corresponds to only a part of the substrate. Accordingly, among the energy irradiated onto the substrate, an energy of the laser beams 11 irradiated onto a place except the area to be machined 98 is wasteful, and there is a problem that an energy efficiency is deteriorated.

### SUMMARY OF THE INVENTION

The present invention is made by taking the problems mentioned above into consideration, and an object of the present invention is to provide a laser machining apparatus which can effectively machine a fine portion.

In accordance with the present invention, there is provided a laser machining apparatus which irradiates laser beams onto a subject to be machined so as to perform a machining, comprising:

an ultraviolet rays laser apparatus having an unstable resonator; and

a condenser array having a plurality of condensers for irradiating the laser beams onto the subject to be machined.

The laser beams emitted from the unstable resonator have a high parallel characteristic and can be accurately condensed at a desired position by inputting the laser beams into the condensers. Accordingly, it is possible to improve a machining accuracy of the laser machining apparatus.

Further, the laser machining apparatus in accordance with the present invention is provided with an intensity distribution converting optical part for converting an intensity distribution of the laser beams into an optional distribution.

Accordingly, since the intensity distribution of the laser beams can be converted in a desired manner, it is possible to apply an even machining to all the surface of the subject to be machined, for example, by making the intensity distribution even.

Further, for example, in the case that a density of a machining portion on the subject to be machined is different in correspondence to the area, it is preferable to make an energy density of the laser beams irradiated onto the area having a high density of the machining portion high and make the energy density in the area having a low density of the machining portion low. Accordingly, the laser beams reflected or absorbed by a light shading portion of the condenser array at a time of machining are reduced and more energy is used for machining, so that a machining efficiency can be improved.

Further, for example, in the case of irradiating the laser beams onto the condenser array having the condensers with different diameters, the laser beams having an even energy density can be irradiated to all the holes by irradiating the laser beams onto the condenser array having a large diameter in a manner as to reduce the energy density of the laser beams. Accordingly, excessive laser beams are not irradiated onto partial holes and a machining accuracy can be improved.

Further, the laser machining apparatus in accordance with the present invention is structured such that the ultraviolet rays laser apparatus is an injection locking type laser apparatus.

A parallel characteristic of the laser beams is increased and a condensing characteristic is improved by setting the laser apparatus to the injection locking type. Further, it is possible to increase a pulse energy per one pulse oscillation at a time when the ultraviolet rays laser apparatus oscillates the pulses. Accordingly, it is possible to improve a machining process capacity per a unit time, that is, a through-put, by a less pulse number, and a productivity can be improved.

Further, the laser machining apparatus in accordance with the present invention is structured such that the condensers of the condenser array are arranged one to one in correspondence to an arrangement of machining positions of the subject to be machined.

Accordingly, since the laser beams are irradiated only at the machining positions, the places other than the machining positions are not damaged by the laser beams. Further, it is not necessary to shade the place except the machining positions, and it is easy to prepare for machining. A rate of the laser beams used for machining is increased and an energy efficiency is improved.

Further, the laser machining apparatus in accordance with the present invention is structured such that the condenser array is arranged so that the laser beams condensed by the respective condensers are respectively condensed or substantially condensed on the surface of the subject to be machined.

Accordingly, since a beam waist having the smallest cross sectional area of the laser beams is positioned on the surface of the subject to be machined, it is possible to piece a hole having a very fine diameter to be machined substantially equal to the beam waist, for example, in the case of piercing. Further, it is possible to machine a fine hole at a narrow interval at one time. It is also applicable to various kinds of laser machining such as an annealing, an etching and the like.

### BRIEF DESCRIPTION OF THE DRAWINGS

FIG. 1 is a schematic view of a whole of a laser machining apparatus in accordance with a first embodiment of the present invention;

FIG. 2 is a schematic view of a structure of an excimer laser apparatus shown in FIG. 1;

FIG. 3 is a schematic view of a shape of a laser beam shown in FIG. 2 in a front view;

FIG. 4 is a plan view of a Fresnel lens in accordance with the first embodiment;

FIG. 5 is a side elevational view of the Fresnel lens shown in FIG. 4;

FIG. 6 is an enlarged side elevational view showing another structure embodiment of the Fresnel lens shown in FIG. 4;

FIG. 7 is a schematic view showing another structure embodiment of the excimer laser apparatus shown in FIG. 1;

FIG. 8 is an enlarged cross sectional view of a micro lens array shown in FIG. 1;

FIG. 9 is a schematic view of a whole of a laser machining apparatus in accordance with a second embodiment;

FIG. 10 is a schematic view of a structure of an intensity distribution converting optical part shown in FIG. 9;

FIG. 11 is a schematic view of another structure embodiment of the intensity distribution converting optical part shown in FIG. 9;

FIG. 12 is a schematic view of a whole of a laser machining apparatus in accordance with a third embodiment;

FIG. 13 is a side elevational view of a micro lens array and a subject to be machined in accordance with a fourth embodiment;

FIG. 14 is a schematic view of a structure of an intensity distribution converting optical part in accordance with the fourth embodiment;

FIG. 15 is a schematic view of a structure of an excimer laser apparatus in accordance with the fourth embodiment;

FIG. 16 is a schematic view of intensity distribution controlling means by a polarization beam splitter in accordance with the fourth embodiment;

FIG. 17 is a plan view of a micro lens array in accordance with a fifth embodiment;

FIG. 18 is a plan view of a micro lens in accordance with a sixth embodiment;

FIG. 19 is a schematic view showing a condensation of the laser beams passing thorough the micro lens shown in FIG. 18;

FIG. 20 is a schematic view showing another structure embodiment of the micro lens shown in FIG. 18;

FIG. 21 is a schematic view showing a whole structure of a laser machining apparatus in accordance with a seventh embodiment;

FIGS. 22, 23 and 24 are schematic views of a machining procedure example in accordance with the seventh embodiment;

FIG. 25 is a schematic view of a laser machining apparatus in accordance with a first prior art;

FIG. 26 is a schematic view of a part of a laser machining apparatus in accordance with a second prior art; and

FIG. 27 is a schematic view of an annealing apparatus in accordance with a third prior art.

### DETAILED DESCRIPTION OF THE PREFERRED EMBODIMENTS

A description will be given in detail of first to seventh embodiments in accordance with the present invention with reference to the accompanying drawings. In this case, in each of the embodiments, the same reference numerals will be attached to the same elements as those in the drawings used for explaining the prior arts and those in the drawings used for explaining the previous embodiment with respect to the present embodiment, and an overlapping description will be omitted.

At first, a description will be given of a first embodiment.

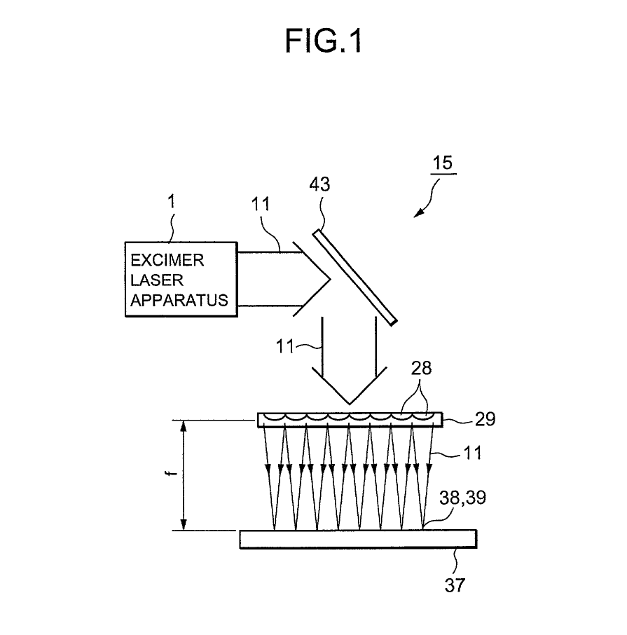

FIG. 1 shows a whole structure of a laser machining apparatus in accordance with the first embodiment. A laser machining apparatus 15 is provided with an excimer laser apparatus 1 oscillating laser beams 11, and a micro lens array 29 having micro lenses 28 arranged in the same pattern as that of holes 39 formed on a subject to be machined 37 such as a printed circuit board or the like.

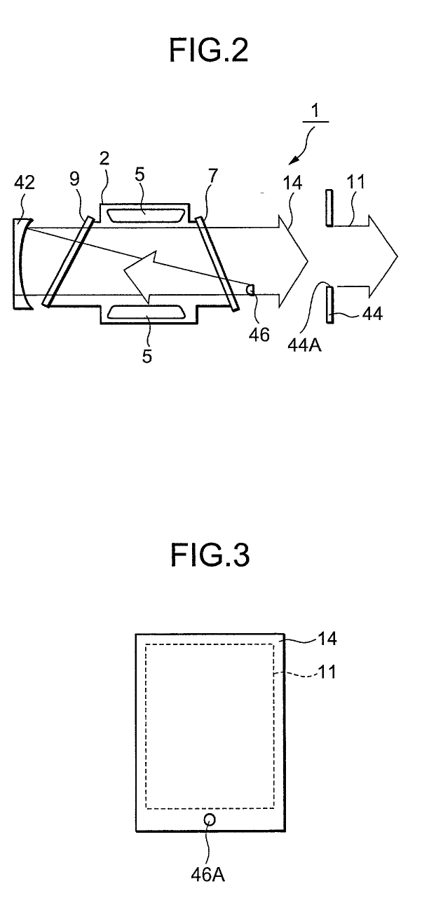

FIG. 2 shows a structure of an excimer laser apparatus 1. The excimer laser apparatus 1 is provided with a laser chamber 2 filled with a laser gas, for example, containing F₂, Kr and Ne, and a front window 7 and a rear window 9 which are provided in both end portions of the laser chamber 2.

A convex mirror 46 is provided in one end side in a lower portion in FIG. 2 of an outer side in front of the front window 7, and a concave mirror 42 is provided in an outer side at the rear of the rear window 9, so that an unstable resonator 42, 46 is constituted by the convex mirror 46 and the concave mirror 42. Further, discharge electrodes 5 and 5 are placed at predetermined positions within the laser chamber 2, and a high voltage can be applied by a high voltage power source (not shown).

In FIG. 1, the laser beams generated within the laser chamber 2 are reflected by the convex mirror 46, reflected to the concave mirror 42 and emitted from a periphery of the convex mirror 46. Then, during reciprocating within the laser chamber 2, the laser beams are taken out as emitting laser beams 14 which are vertically limited between the electrodes and laterally limited between the widths of the electrodes respectively and have a substantially rectangular cross sectional shape.

Since at this time, the emitted laser beams 14 are reflected by the convex mirror 42 so as to be emitted as parallel beams, a parallel characteristic becomes higher than the laser beams emitted from the excimer laser apparatus provided with the normal stable type resonator.

FIG. 3 shows a shape of the laser beams 14 emitted from the excimer laser apparatus 1 in a front view. As shown in FIG. 3, the light beams are not emitted from the portion corresponding to the convex mirror 46 in the lower portion, and a circular shadow 46A is generated. Then, as shown in FIG. 2, an aperture 44 having a rectangular opening portion 44A is arranged in the front portion of the laser chamber 2, and the aperture 44 cuts out the rectangular laser beams 11 in such a manner as to avoid the shadow 46A generated by the convex mirror 46 so as to use for machining. Otherwise, the opening portion of the aperture 44 is formed in a circular shape and a cross sectional shape of the laser beams 11 is formed in a circular shape.

As mentioned above, the laser beams 11 emitted from the unstable resonator 42, 46 and having a high parallel characteristic are reflected downward by a mirror 43 as shown in FIG. 1, and enter the condenser array 29 (hereinafter, refer to as a micro lens array 29).

In this case, a description will be given of a case of piercing a plurality of holes 39 having the same diameter to be machined. As shown in FIG. 1, a plurality of fine condensers 28 (hereinafter, refer to as micro lenses 28) having the same focal length are arranged in the micro lens array 29 one to one in correspondence to a plurality of holes 39 machined in the subject to be machined 37 such as a printed circuit board or the like.

At this time, when setting the focal length of each of the micro lenses 28 to f, the subject to be machined 37 is arranged so that a distance between a principal point of each of the micro lenses 28 and a surface of the printed circuit board becomes equal to the focal length f.

Accordingly, the parallel laser beams 11 irradiated onto the micro lens array 29 are focused on the surface of the subject to be machined 37 by the micro lenses 28, and condensed points 38 (hereinafter, refer to as beam waists 38) having the smallest spot diameter coincide with the surface of the printed circuit board.

The intensity distribution of the laser beams 11 condensed by the micro lenses 28 is constituted by concentric light stripes and dark stripes. At this time, a diameter of the first dark stripe is called as a beam waist diameter W.

The beam waist diameter W can be expressed by the following formula (1) when setting a focal length of the micro lens 28 to f, a lens diameter to φ and a wavelength of the laser beam 11 to λ.

W=2.44λ·f/φ (1)

That is, the laser beams 11 condensed to the beam waist diameter W satisfying the formula (1) are irradiated onto the surface of the printed circuit board.

Then, in the case of actually performing the machining in accordance with the condition mentioned above, the hole 39 having a diameter to be machined d substantially equal to the beam waist diameter W is formed so as to extend therethrough. That is, it is possible to obtain the hole 39 having a target desired diameter to be machined d by determining the focal length f and the lens diameter φ of the micro lens 28.

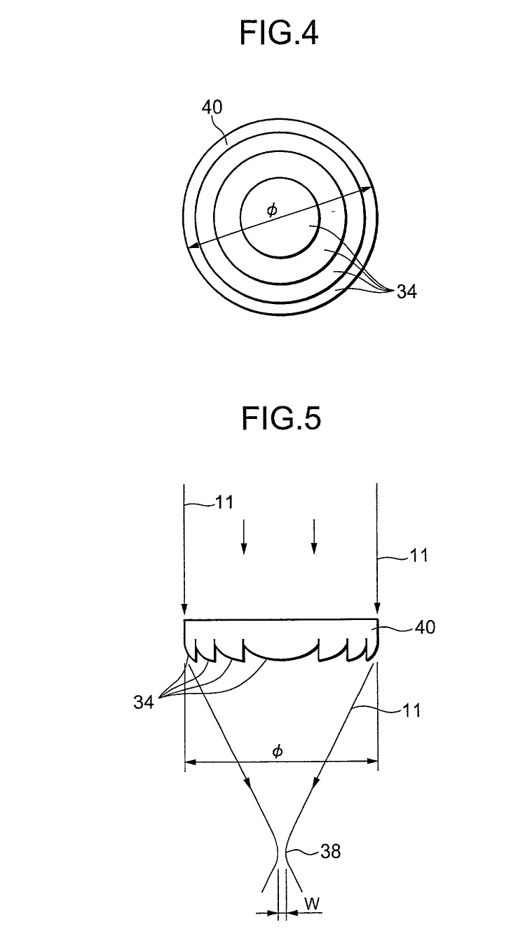

In this case, a description is given of the case that the micro lens 28 is a spherical convex lens in order to simplify, however, the spherical convex lens may be replaced, for example, by a Fresnel lens. FIG. 4 is a plan view of a Fresnel lens 40 and FIG. 5 is a side elevational view thereof. The Fresnel lens 40 is obtained by forming diffraction gratings 34 in a concentric shape, and the laser beams 11 are condensed due to diffraction.

Otherwise, the structure may be made such that ring-shaped light transmitting portions transmitting the laser beams 11 therethrough and ring-like light shading portions shading the laser beams 11 are alternately in a concentric manner.

Since the Fresnel lens 40 can be produced, for example, in accordance with a photolithography process and a multiplicity of structures each having a small lens diameter φ can be accurately produced, the Fresnel lens 40 is preferable to the micro lens array 29.

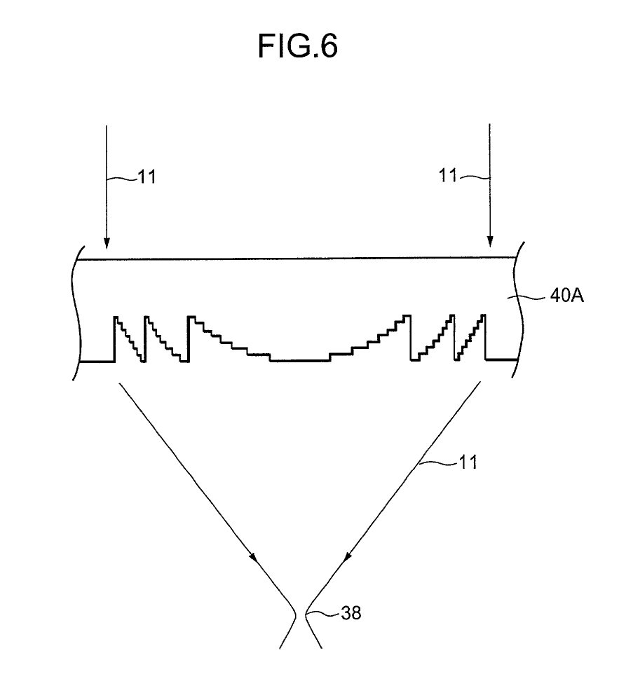

Further, the Fresnel lens 40 mentioned above may employ a binary optics 40A as shown in FIG. 6. The binary optics 40A is structured such as to form an optical part by diffraction gratings formed in a step shape having a level difference about a wavelength. Since the surface of the optical part is constituted by a combination of lines not by a curved surface, it is easy to design by a computer and it is possible to accurately produce in accordance with a photolithography process.

As mentioned above, in accordance with the first embodiment, the piercing process is performed by irradiating the laser beams 11 obtained by cutting out a part of the emitted laser beams 14 oscillated from the excimer laser apparatus 1 having the unstable resonator 42, 46 onto the micro lens array 29.

The emitted laser beams 14 emitted from the excimer laser apparatus 1 having the unstable resonator 42, 46 has a small divergent angle, and have a strong parallel characteristic even when not passing through a pin hole or the like. Since the laser beams 11 having a high parallel characteristic are irradiated onto the condensers such as the micro lenses 28 or the like, a condensing characteristic of the laser beams 11 passing through the micro lenses 28 is improved. Accordingly, it is possible to condense the laser beams 11 to be small close to a diffraction limit and it is possible to pierce the holes 39 having a smaller diameter, whereby a fineness of machining can be improved. Since it is not required to position the laser beams 11 to the pin hole or the like, a lot of process and labor are not required.

In accordance with the first embodiment, the convex mirror 46 is shifted to the end side with respect to the center of the concave mirror 42. Accordingly, it is possible to cut the shadow portion of the emitting laser beams; 14 generated by the convex mirror 46 by the aperture 44 so as to use as the laser beams 11 having no shadows. Therefore, in comparison with the donut-shaped laser beams 11 emitted from the conventional unstable resonator, a condensing characteristic can be improved and a fine machining can be performed.

Further, the structure is made such that the subject to be machined 37 is arranged at the focal point of the micro lens 28 and the beam waists 38 of the condensed laser beams 11 are positioned on the surface of the subject to be machined 37. Accordingly, it is possible to obtain the hole 39 having substantially the same diameter to be machined as the beam waist diameter W, and a fineness of machining can be improved.

Further, since the diameter to be machined d of the hole 39 becomes substantially the same as the beam waist diameter W, it is possible to freely control the diameter to be machined d of the hole 39 by changing the focal length f and the lens diameter φ of the micro lens 28. With respect to the diameter to be machined d of the required hole 39, a specification of the focal distance f, the lens diameter φ and the like of the micro lens 28 can be easily determined.

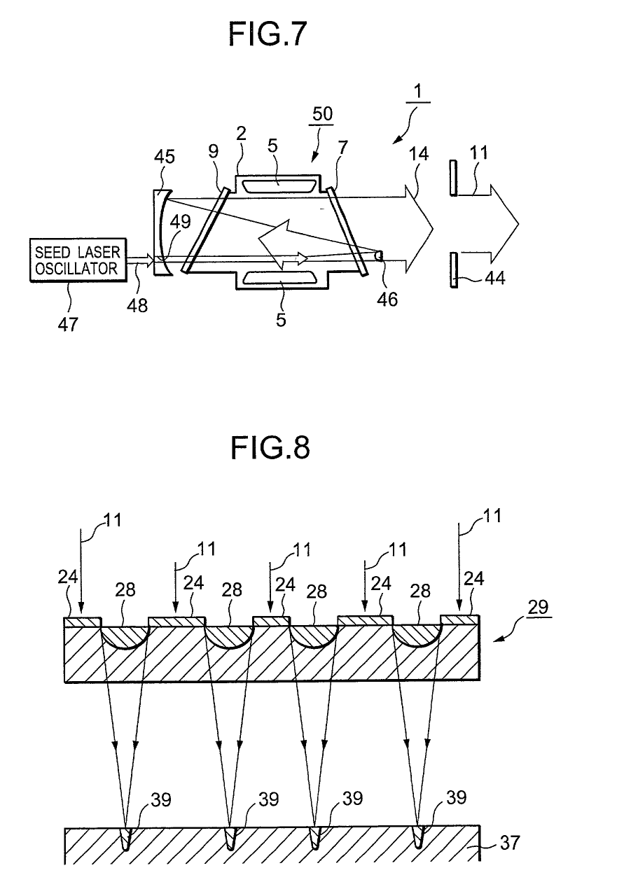

FIG. 7 shows another structure embodiment of the excimer laser apparatus 1 in accordance with the first embodiment.

The excimer laser apparatus 1 is provided with a seed laser oscillator 47 pulse oscillating seed beams 48, and an oscillator 50 amplifying the seed beams 48. That is, the excimer laser apparatus 1 is of an injection locking type. The seed laser oscillator 47 preferably employs, for example, a structure obtained by wavelength converting solid laser beams through a wavelength converting device or a compact excimer laser apparatus.

The oscillator 50 is provided with the laser chamber 2 filled with a laser gas, for example, containing F₂, Kr and Ne, and the front window 7 and the rear window 9 which are provided in both end portions of the laser chamber 2.

A convex mirror 45 with a hole having an injection hole 49 in a lower portion is provided in an outer side at the rear of the rear window 9, and a convex mirror 46 is provided in an outer side in front of the front window 7 in such a manner as to oppose to the injection hole 49, respectively, thereby constituting unstable resonators 45 and 46. Further, the discharge electrodes 5 and 5 are placed at predetermined positions within the laser chamber 2, and a high voltage can be applied by a high voltage power source (not shown).

The seed beams 48 oscillated from the seed laser oscillator 47 transmits through the rear window 9 from the injection hole 49 of the concave mirror with the hole 45 and enter the oscillator 50 as the parallel beams having a high parallel characteristic. The seed beams 48 reflected by the convex mirror 46 are reflected to the concave mirror with the hole 45 and are emitted from the periphery of the convex mirror 46. Then, during reciprocating within the laser chamber 2, the pulse output is amplified while keeping a wavelength and a spectral width due to an electric discharge applied between the discharge electrodes 5 and 5 in synchronous with the seed beams 48. Then, the beams can be taken out as emitting laser beams 14 which are vertically limited between the discharge electrodes 5 and 5 and laterally limited between the widths of the discharge electrodes respectively and have a substantially rectangular cross sectional shape.

At this time, a parallel characteristic of the seed beams 48 can be improved by inputting the seed beams 48 from the small injection hole 49. Further, among the incident seed beams 48, only components having higher parallel characteristic are reflected by the convex mirror 46, and are amplified within the laser chamber 2. Accordingly, it is possible to obtain the emitting laser beams 14 having a higher parallel characteristic in comparison with the excimer laser apparatus having the unstable resonator 42, 46 which is not of an injection locking type shown in FIG. 2.

In the emitting laser beams 14, the light beams are not emitted from the portion corresponding to the convex mirror 46 in the lower portion in the same manner as that shown in FIG. 3, and a circular shadow 46A is generated. Accordingly, the laser beams are used for machining by cutting out the laser beams 11 in such a manner as to avoid the shadow 46A with employing the aperture 44, in the same manner as described above.

A more precise machining can be performed by employing the laser beams 11 having a high parallel characteristic as the light source and using the laser machining apparatus 15 shown in FIG. 1.

Further, with respect to the micro lens array 29, it is preferable to provide with shading means for preventing the laser beams 11 from transmitting therethrough in the place where the micro lens 28 is not provided. Without the shading means, the laser beams 11 transmitting through the place except the micro lenses 28 are irradiated onto the subject to be machined 37, so that there is a case that the surface of the subject to be machined 37 is melted and a undesired place is machined.

FIG. 8 shows an enlarged cross section of the micro lens array 29. A shading film 24 absorbing or reflecting the laser beams 11 and constituted by a metal film or a dielectric film is coated in a place except the micro lenses 28 of the incident surface at which the laser beams 11 enter the micro lens array 29. Accordingly, the laser beams 11 do not transmit through the place except the micro lenses 28 of the micro lens array 29. Accordingly, the laser beams 11 which are not condensed by the micro lenses 28 are not irradiated onto the subject to the machined 37 and the places other than the predetermined place are not machined.

Next, a description will be given of a second embodiment.

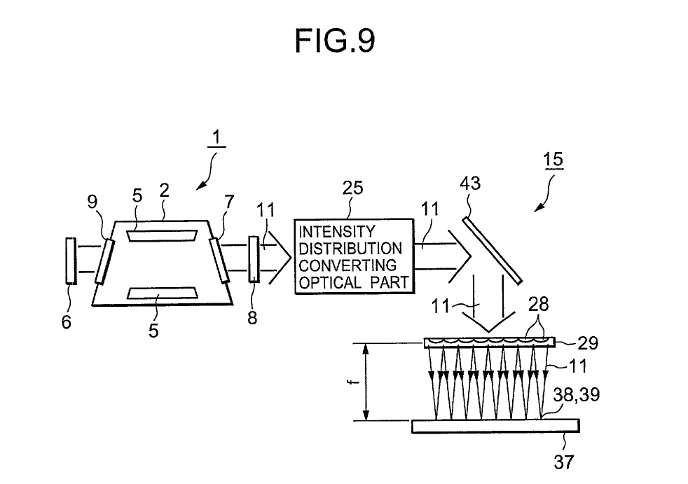

FIG. 9 shows a whole structure of a laser machining apparatus in accordance with the second embodiment. A laser machining apparatus 15 is provided with an excimer laser apparatus 1 oscillating laser beams 11, an intensity distribution converting optical part 25 spreading a beam width while keeping a parallel characteristic of the laser beams 11 so as to make an intensity distribution even, and a micro lens array 29 having micro lenses 28 arranged in the same pattern as that of holes 39 formed on a printed circuit board corresponding to a subject to be machined. Among the intensity distribution converting optical part 25 for converting the intensity distribution of the light beams, a structure of making the intensity distribution even is called as a homogenizer.

The excimer laser apparatus 1 is provided with a laser chamber 2 filled with a laser gas, and a front window 7 and a rear window 9 which are provided in both end portions of the laser chamber 2. A front mirror 8 and a rear mirror 6 are respectively provided in an outer side in front of the front window 7 and in an outer side at the rear of the rear window 9, so that stable resonators 6 and 8 are constituted by the front mirror 8 and the rear mirror 6. The laser beams 11 generated within the laser chamber 2 transmit through the front window 7 and the rear window 9, are totally reflected by the rear mirror 6 so as to transmit through the front mirror 8, and are emitted to an outer portion. In this case, both of the front mirror 8 and the rear mirror 6 may be plane mirrors or at least one of them may be a concave mirror.

The laser beams 11 emitted from the stable resonator 6, 8 has an intensity distribution in which a center portion is strong and a peripheral portion is weak. In order to make the intensity distribution even, the laser beams 11 are input to the intensity distribution converting optical part 25.

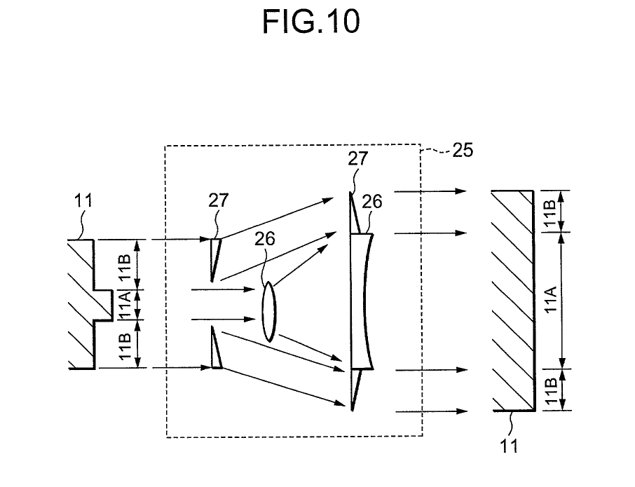

FIG. 10 shows a cross sectional structure of the intensity distribution converting optical part 25 in accordance with the second embodiment. The intensity distribution converting optical part 25 is provided with lens expanders 26 and 26 constituted by a group of lenses arranged in a center portion, and a pair of prisms 27 and 27 arranged all around the periphery of an outer periphery of the lens expanders 26 and 26.

In this case, a description will be given of an operation of the intensity distribution converting optical part 25 with exemplifying the laser beams 11 having an intensity distribution that an intensity of center laser beams 11A passing through the center portion has about twice an intensity of peripheral laser beams 11B passing through the peripheral portion.

When the laser beams 11 enter the intensity distribution converting optical part 25, the center laser beams 11A enter the lens expanders 26 and 26 and are expanded to about twice the diameter while keeping a parallel characteristic. On the contrary, the peripheral laser beams 11B are expanded to the peripheral portion of the expanded center laser beams 11A by the pair of prisms 27 and 27 while keeping a width in a diametrical direction. That is, the lens expanders 26 and 26 and the pair of prisms 27 and 27 both form the beam expanders 26 and 27 for expanding the laser beams 11. Accordingly, since the peripheral laser beams 11B are expanded at a small expansion rate while the center laser beams 11A are expanded at a large expansion rate, a difference of intensity between the both is reduced and the intensity distribution is made even.

As mentioned above, by combining the beams expanders 26 and 27 in which the expanding rates are changed in the center portion and the outer peripheral portion so as to constitute the intensity distribution converting optical part 25, it is possible to obtain the laser beams 11 which keep the parallel characteristic and have an even intensity distribution.

In this case, in the description mentioned above, the description is given of the embodiment in which the center portion has about twice the intensity of the peripheral portion, however, the intensity distribution of the actual laser beams 11 is structured such that the center portion is continuously increased. Accordingly, with respect to the continuous intensity distribution mentioned above, the structure may be made such that a plurality of lens expanders 26 and 26 and the pair of prisms 27 and 27 are concentrically arranged and the expanding rate is continuously changed so that the center portion has a high expanding rate and the peripheral portion has a low expanding rate.

Further, in the case that in place of the lens expanders 26 and 26 and the pair of prisms 27 and 27, transmitting type diffraction gratings are employed so as to expand the laser beams 11, it is possible to further smoothly and continuously change the expanding rate of the laser beams 11. That is, it is possible to obtain the laser beams 11 having more even intensity distribution.

As mentioned above, in accordance with the second embodiment, the laser beams 11 in which the intensity distribution is made even by the intensity distribution converting optical part 25 are irradiated onto the micro lens array 29. Accordingly, since the laser beams 11 having a substantially even intensity are irradiated onto the individual micro lenses 28, it is possible to machine each of the holes 39 by substantially the same energy density. Therefore, since the machining of each of the holes 39 is finished substantially at the same time, no surplus energy is irradiated, the diameter to be machined d of the hole 39 does not become inaccurate and the shape of the hole 39 does not become unstable.

Further, the intensity distribution converting optical part 25 is structured such that the beam expanders 26 and 27 having different expanding rates are combined. Accordingly, it is possible to make the intensity distribution even while keeping the parallel characteristic of the laser beams 11. Therefore, the condensing characteristic of the laser beams 11 condensed by the micro lenses 28 can be improved and a fine machining can be performed.

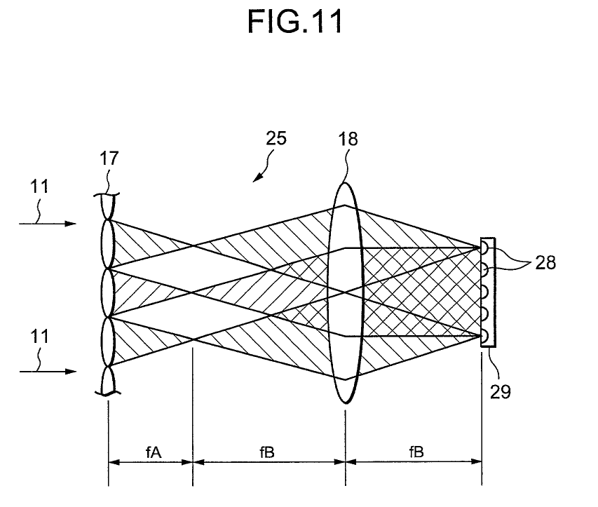

FIG. 11 shows another structure embodiment of the intensity distribution converting optical part 25 in accordance with the second embodiment. The intensity distribution converting optical part 25 is provided with a fly eye lens 17 and an integrator lens 18 having a long focal distance. A distance between the fly eye lens 17 and the integrator lens 18 is set to a value obtained by adding a focal length fB of the integrator lens 18 to a focal length fA of the fly eye lens 17. Further, by setting a distance between the integrator lens 18 and the micro lens array 29 to the focal length fB of the integrator lens 18, it is possible to collect all the laser beams 11 passing through the integrator lens 18 to the micro lens array 29. Then, the longer the focal length fB is made, the more the parallel characteristic of the laser beams 11 entering the micro lens array 29 is increased.

As mentioned above, by combining the fly eye lens 17 and the integrator lens 18 so as to constitute the intensity distribution converting optical part 25, the intensity distribution is made even and it is possible to irradiate the laser beams 11 having a high parallel characteristic onto the micro lens array 29.

Next, a description will be given of a third embodiment.

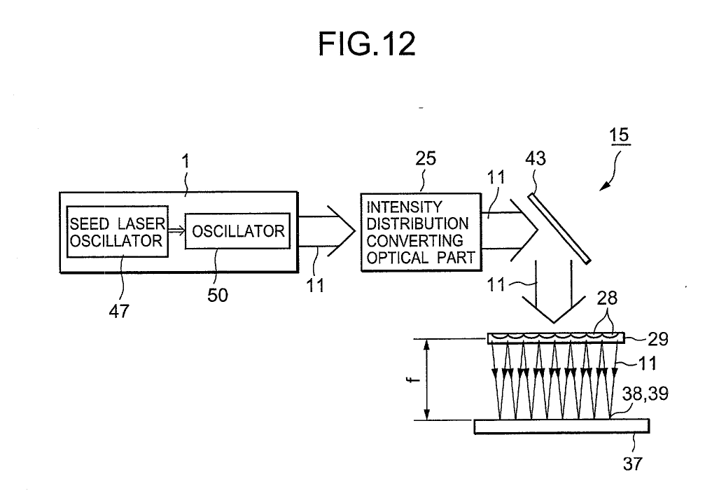

FIG. 12 shows a whole structure of a laser machining apparatus in accordance with the third embodiment. A laser machining apparatus 15 is provided with an excimer laser apparatus 1 oscillating laser beams 11, an intensity distribution converting optical part 25 spreading a beam width while keeping a parallel characteristic of the laser beams 11 so as to make an intensity distribution even, and a micro lens array 29 having micro lenses 28 arranged in the same pattern as that of holes formed on a printed circuit board corresponding to a subject to be machined.

In this case, the structure of the excimer laser apparatus 1 is the same as that shown in FIG. 7, and the structure of the intensity distribution converting optical part 25 is also the same as that shown in FIG. 10.

As mentioned above, in accordance with the third embodiment, with respect to the laser beams 11 emitted from the injection locking type excimer laser apparatus 1 and having a very high parallel characteristic, the intensity distribution is made even while the parallel characteristic is kept by the intensity distribution converting optical part 25.

Accordingly, the laser beams 11 emitted from the intensity distribution converting optical part 25 have a high parallel characteristic and an even intensity distribution. Since the laser beams 11 having a high parallel characteristic are irradiated onto the micro lens array 29, a condensing characteristic of the laser beams 11 can be improved and it is possible to condense the laser beams 11 to a small size near a diffraction limit. Accordingly, it is possible to pierce the hole 39 having smaller diameter and a fine characteristic of the machining is improved.

Further, since the intensity distribution of the laser beams 11 is made even, the laser beams 11 having a substantially even intensity can be irradiated onto the individual micro lenses 28. That is, no surplus energy is irradiated to the hole 39, and it is possible to pierce the hole having an accurate shape.

Next, a description will be given of a fourth embodiment. In accordance with the fourth embodiment, a description will be given of the case that holes having different diameters to be machined are machined at one time.

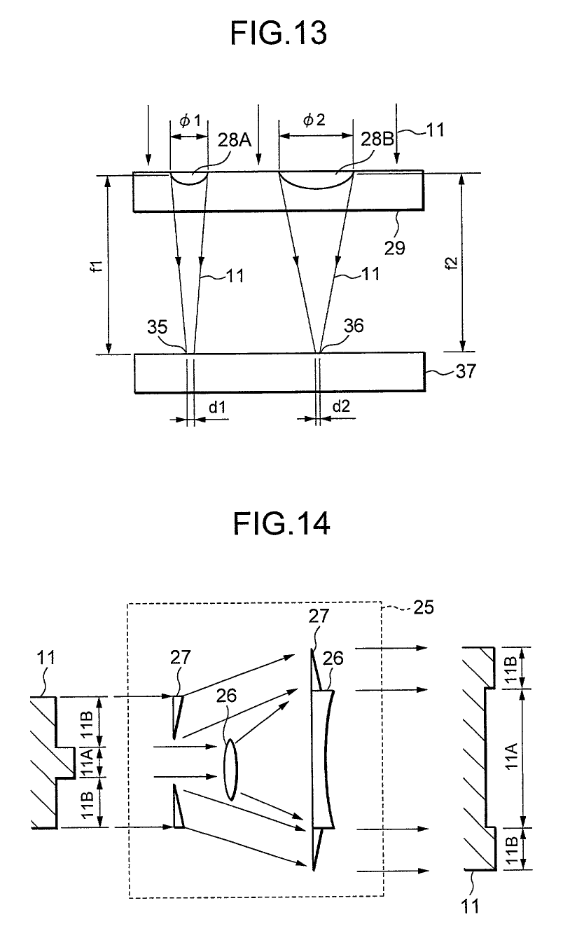

FIG. 13 shows a side surface of the micro lens array 29 and the subject to be machined 37. In order to make the description simple, it is supposed that a large hole 35 having a large diameter to be machined d1 and a small hole 36 having a small diameter to be machined d2 are simultaneously machined by two micro lenses 28A and 28B, respectively.

When respectively setting focal lengths of the micro lenses 28A and 28B to f1 and f2 and setting lens diameters thereof to φ1 and φ2, in order to accurately obtain the desired diameters to be machined d1 and d2 of the respective holes 35 and 36, it is necessary to coincide the focal points of the micro lenses 28A and 28B with the surface of the subject to be machined 37. This can be obtained by making the focal lengths f1 and f2 of the micro lenses 28A and 28B equal to each other and coinciding the focal length f1 (=f2) with the distance between the micro lens array 29 and the surface of the subject to be machined 37.

In this case, the lens diameter φ of the micro lens 28 means an outer diameter of the outermost diffraction grating 34, in the case of the Fresnel lens 40 shown in FIGS. 4 and 5. Further, in the case of the Fresnel lens in which annular light transmitting portions and shading portions are alternately provided so as to form a concentric circle, the lens diameter means an outer diameter of the light transmitting portion in the most outer peripheral side.

The diameters to be machined d1 and d2 of the holes 35 and 36 machined by the respective micro lenses 28A and 28B can be determined by substituting the condition mentioned above for the following formulas (2) and (3) obtained by modifying the formula (1). In other words, it is possible to machine the respective holes 35 and 36 having the desired diameters to be machined d1 and d2 by changing the lens diameters φ1 and φ2 of the respective micro lenses 28A and 28B.

φ1=2.44λ·f1/d1 (2)

φ2=2.44λ·f2/d2 (3)

in which f1=f2.

At this time, when irradiating the laser beams 11 having the same energy density onto each of the micro lenses 28A and 28B, the following problems are generated. That is, a quantity of light of the laser beams 11 passing through the micro lens 28B having the large lens diameter φ2 is great, and a quantity of light of the laser beams 11 passing through the micro lens 28A having the small lens diameter φ1 is small. Accordingly, since an energy which is irradiated to the small hole 36 is higher than an energy which is irradiated to the large hole 35, the machining of the small hole 36 is finished earlier than the large hole 35. As a result, a surplus energy is irradiated to the small hole 36 by the machining of the large hole 35 is finished, so that there is a case that the diameter to be machined d2 of the small hole 36 becomes larger than the desired value.

In order to prevent this, a time required for machining is adjusted to be substantially the same by attenuating the laser beams 11 entering the micro lens 28B having the large lens diameter φ2 by a neutral density filter (ND filter) or the like. An attenuation rate at this time is set to be substantially in inverse proportion to an area of the micro lens 28B (that is, a square of the lens diameter φ2).

Otherwise, the intensity distribution of the laser beams 11 may be controlled so as to form a concentric circle shape by the intensity distribution converting optical part 25. Such an embodiment will be shown below.

In the subject to the machined 37 such as the printed circuit board or the like, there is a case of concentrically machining the holes 39 having different diameters to be machined d. For example, in the case of machining the small hole 36 having the small diameter to be machined d2 near the center portion of the subject to be machined 37 and the large hole 35 having the large diameter to be machined d1 in the peripheral portion thereof, the micro lens 28B having the large lens diameter φ2 is arranged in the center portion and the micro lens 28A having the small lens diameter φ1 is arranged in the peripheral portion, respectively.

FIG. 14 shows a cross sectional structure of the intensity distribution converting optical part 25 in accordance with the fourth embodiment. The intensity distribution converting optical part 25 is structured such as to expand the center laser beams 11A at a large expanding rate in comparison with the structure shown in the second embodiment. Accordingly, the laser beams 11 passing through the intensity distribution converting optical part 25 are structured such that the center laser beams 11A are weaker than the peripheral laser beams 11B.

When irradiating the laser beams 11 onto the micro lens array 29, strong beams are irradiated onto the micro lens 28A having the small lens diameter φ1 and weak beams are irradiated onto the micro lens 28B having the large lens diameter φ2, respectively. Accordingly, the quantity of light of the laser beams 11 passing through each of the micro lenses 28A and 28B is substantially the same, the laser beams 11 having a substantially even energy density are irradiated to each of the holes 35 and 36, and the machining is performed. Therefore, the machining can be finished substantially at the same time, and the desired diameters to be machined d1 and d2 can be obtained.

This technique is also effective, for example, in the case that the hole 35 to be machined exists only in the periphery of the subject to be machined 37. In this case, the structure is made such that the intensity distribution of the laser beams 11 passing through the intensity distribution converting optical part 25 becomes weaker in the center portion. Otherwise, the intensity distribution of the laser beams 11 is formed in a donut shape in which the light beams are hardly provided in the center portion.

In this case, the description is given of the case of machining the small hole 36 having the small diameter to be machined d2 in the center portion, however, the same description can be applied to the case of machining the small hole 36 in the peripheral portion. That is, the structure is made such that the expanding rate of the center laser beams 11A is reduced, whereby the intensity of the Laser beams 11 emitting from the intensity distribution converting optical part 25 becomes strong in the center portion and weak in the peripheral portion.

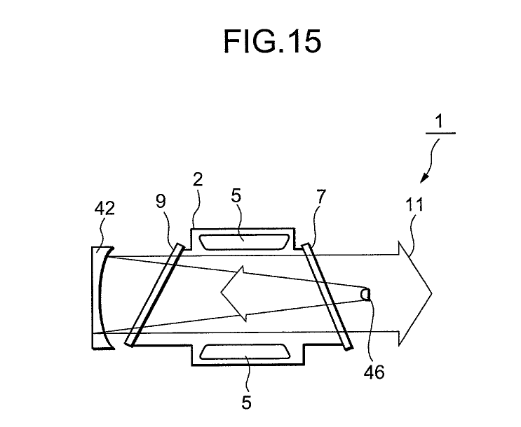

Further, in the case that the hole 35 to be machined exists only in the peripheral portion of the subject to be machine 37, the excimer laser apparatus 1 is structured such as to be provided with the unstable resonator 42, 46 having the convex mirror 46 in the center portion as shown in FIG. 15. Accordingly, since the laser beams 11 are formed in a donut shape, the subject to be machined 37 can be machined without wasting the laser beams 11.

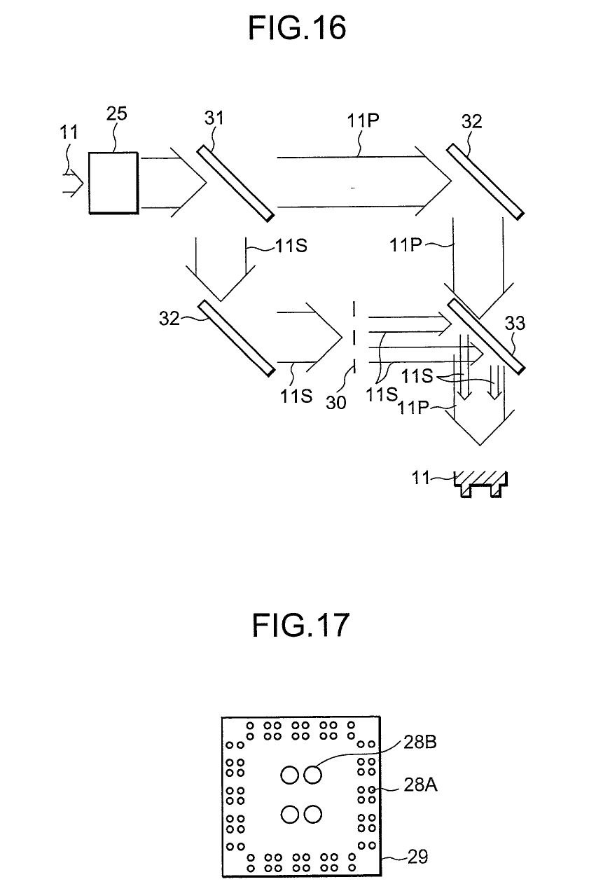

Further, as means for partly changing the intensity distribution of the laser beams 11 not in a concentric shape, there is an example using a polarization beam splitter shown in FIG. 16.

In this case, the even laser beams 11 emitted from the intensity distribution converting optical part 25 are divided into two portions comprising a P-polarized component 11P and an S-polarized component 11S by a first polarization beam splitter 31. The P-polarized component 11P transmitting through the first polarization beam splitter 31 is reflected by a mirror 32 and enters a second polarization beam splitter 33 from the above in FIG. 16.

On the contrary, the S-polarized component 11S reflected by the first polarization beam splitter 31 is reflected by the mirror 32, thereafter transmits through the opening portion of the mask 30 so as to make the intensity density be changed, and enters the second polarization beam splitter 33. Both of the polarized lights 11P and 11S are overlapped with each other by the second polarization beam splitter 33, the intensity at the portion to which the S-polarized component 11S is irradiated is increased, and it is possible to a desired energy density.

As mentioned above, in the case that the distribution of the size of the holes 39 is not formed in a concentric circular shape, it is also possible to overlap the laser beams 11 by the first and second polarization beam splitters 31 and 33 with each other so as to control the intensity distribution, thereby machining at the same energy density at the same time.

As mentioned above, in accordance with the fourth embodiment, the micro lenses 28A and 28B having the different lens diameters φ1 and φ2 are arranged on the micro lens array 29 on the basis of the different diameters to be machined d1 and d2 of the holes to be machined. Accordingly, it is possible to machine the holes 35 and 36 having the different diameters to be machined d1 and d2 at the same time and it is possible to reduce a time required for machining.

Further, since the lens diameters φ1 and φ2 of the respective micro lenses 28A and 28B are determined on the basis of the predetermined formulas (2) and (3), it is possible to easily determine the specification constituted by the focal lengths f1 and f2, the lens diameters φ1 and φ2 and the like, with respect to the diameters to be machined d1 and d2 of the respective desired holes 35 and 36.

Further, it is possible to accurately machine the holes 35 and 36 having the desired diameters to be machined d1 and d2 on the basis of the beam waist diameter W by coinciding the focal length f1 and f2 of the respective micro lenses 28A and 28B with each other and coinciding the respective focal points with the surface of the subject to be machined 37.

Further, the intensity distribution of the laser beams 11 is controlled by the intensity distribution converting optical part 25 or the like in correspondence to the lens diameters φ1 and φ2 of the respective micro lenses 28A and 28B. Accordingly, since the machining can be performed at substantially the same energy density with respect to the holes 35 and 36 having the different diameters to be machined d1 and d2, the machining can be finished substantially at the same time and it is possible to machine the accurate diameters to be machined d1 and d2. That is, the diameter to be machined d does not become inaccurate due to a surplus energy and the shape of the hole does not become unstable.

Next, a description will be given of a fifth embodiment.

In the subject to be machined 37 such as the printed circuit board or the like, there is a case that a small number of holes 39 each having a small diameter to be machined d are machined near the center portion of the subject to be machined 37 and a large number of holes 39 each having a large diameter to be machined d are machined near the peripheral portion of the subject to be machined 37. In the case mentioned above, when irradiating the laser beams 11 having the intensity distribution made even onto the micro lens array 29, most of the laser beams 11 do not transmit through the micro lenses 28 in the center portion having the small number of holes 39, so that the energy becomes wasteful. Accordingly, it is necessary to effectively machine at a reduced energy by changing the intention distribution of the laser beams 11 irradiated onto the micro lens array 29 in correspondence to the number of the holes 39 to be machined and a numerical aperture of the micro lens 28.

FIG. 17 shows a plan view of the micro lens array 29 in accordance with a fifth embodiment. The micro lenses 28B having the large lens diameter φ2 are roughly arranged in the center portion and the micro lenses 28A having the small lens diameter φ1 are densely arranged in the peripheral portion. Accordingly, the small holes 36 are roughly machined in the center portion and the large holes 35 are densely machined in the peripheral portion. Therefore, an amount of the laser beams 11 passing through the micro lens array 29 after being irradiated onto the peripheral portion is much but an amount of the laser beams 11 passing through the micro lens array 29 after being irradiated onto the center portion is little and most of the laser beams 11 are reflected and are not used for machining.

With respect to the micro lens array 29 mentioned above, the laser beams 11 in which the energy density in the center portion is weakened, for example, by the intensity distribution converting optical part 25 shown in FIG. 14 are irradiated. Accordingly, it is possible to reduce the laser beams 11 reflected or absorbed in the center portion of the micro lens array 27 having a small number of micro lenses 28B.

Accordingly, since more of the energy of the laser beams 11 pass through the micro lens array 29 and are used for machining, it is possible to machine with an improved energy efficiency. Further, since the weak laser beams 11 are irradiated onto the center portion of the micro lenses 28B having the large lens diameter φ2, the energy densities of the laser beams 11 are substantially equal to each other at every holes 35 and 36, and no surplus laser beams 11 are irradiated.

Next, a description will be given of a sixth embodiment.

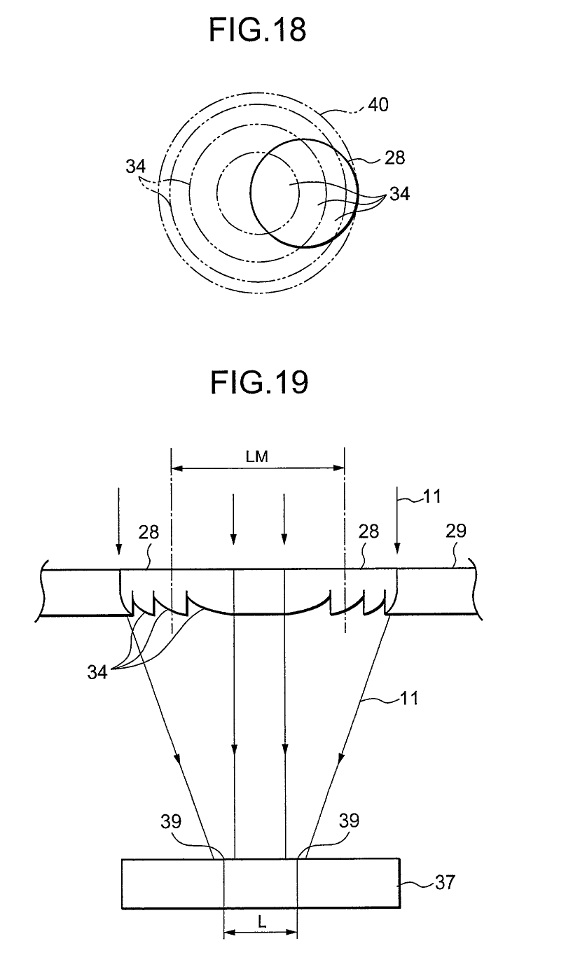

FIG. 18 shows a plan view of the micro lens 28 in accordance with a sixth embodiment. The micro lens 28 is structured by cutting a part of the Fresnel lens 40 formed by concentric diffraction gratings described with reference to FIGS. 4 and 5, and has a circular shape passing through a center of the Fresnel lens 40 and being inner contact with an outer periphery thereof. That is, the diffraction grating exists only in a portion shown by a solid line in FIG. 18, and no diffraction grating exists in a portion shown by a two-dot chain line.

FIG. 19 shows a state of condensing the laser beams 11 passing through each of the micro lenses 28 and 28 mentioned above. The laser beams 11 are shifted from the center of the micro lens 28 and condensed onto a lower portion of a substantially center of the inherent Fresnel lens 40 shown by the two-dot chain line in FIG. 18. Accordingly, it is possible to make an interval between the centers of the holes 39 and 39 (hereinafter, refer to as an interval L) narrower than an interval LM between the centers of the micro lenses 28 and 28 by arranging the micro lenses 28 mentioned above. Therefore, it is possible to machine the hole 39 at the very narrow interval L and it is possible to increase a freedom of machining.

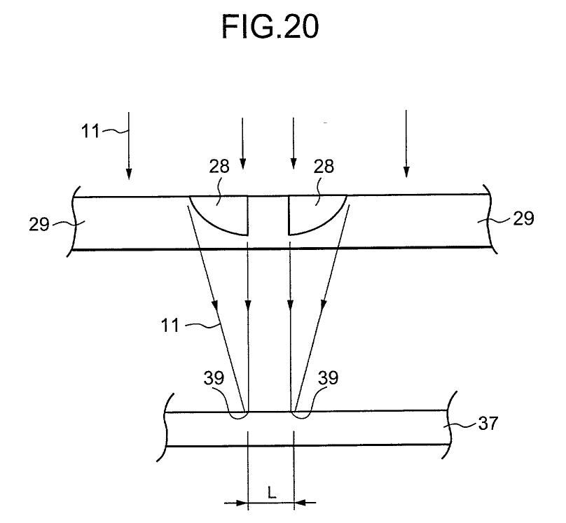

Otherwise, as another embodiment of the micro lens 28, it is; possible to employ a shape obtained by sectioning a spherical convex lens into half as shown in FIG. 20. In accordance with the structure mentioned above, it is possible to make the interval L between the holes 39 and 39 narrow.

As mentioned above, in accordance with the sixth embodiment, the hole 39 is machined by using the micro lens 28 by which the laser beams 11 are shifted and condensed.

In conventional, as shown by the formula (1), in order to machine the hole 39 having a small diameter to be machined d, the micro lens 28 having a large lens diameter φ is required. Accordingly, the interval L is increased as the diameter to be machined d of the hole 39 is reduced, so that in order to machine at the narrow interval L, it is unavoidable to scan the micro lens and machine at plural times.

However, by using the micro lens 28 shown in the sixth embodiment, it is possible to machine the fine hole 39 at one time at the narrow interval L.

Next, a description will be given of a seventh embodiment. The first to sixth embodiments relate to the case of piercing the through hole 39, however, the present invention can be applied to the case of performing the other machining such as an annealing, an etching or the like.

FIG. 21 shows a whole structure of a laser machining apparatus 15 in accordance with a seventh embodiment. The laser beams 11 emitted from the excimer laser apparatus 1 are reflected by the mirror 43 and irradiated onto the micro lens array 29. At this time, the micro lenses 28 are arranged in the micro lens array 29 one to one in correspondence to a machining area 98 of the subject to be machined 37.

The laser beams 11 condensed by the respective micro lenses 28 and 28 are irradiated, for example, onto the respective machining areas 98 and 98 of the subject to be machined 37 in which an amorphous silicone (a-Si) thin film is formed on a surface. Accordingly, in the amorphous silicone thin film in the respective areas 98 and 98, the machining area 98 onto which the laser beams 11 are irradiated is made polycrystalline, and a drive circuit of a liquid crystal is produced by forming a thin film transistor (TFT) in the machining area 98 made polycrystalline.

As mentioned above, in accordance with the seventh embodiment, the micro lenses 28 are provided at the position one to one in correspondence to the machining areas 98 so as to form the micro lens array 29, and the annealing is performed by irradiating the laser beams 11 onto the micro lens array 29. In this case, in addition to the annealing, the present invention can be applied, for example, to various kinds of laser machining such as an etching of excavating a hole having a predetermined depth due to an abrasion, a photochemical reaction etching of performing a chemical reaction at a predetermined position by irradiating the laser beams 11 onto the subject to be machined 37 under a reactive gas circumstance and the like.

As mentioned above, it is possible to irradiate the laser beams 11 onto only the machining area 98 requiring the irradiation of the laser beams 11 by employing the micro lens array 29 so as to perform the machining such as the annealing, the etching and the like. Accordingly, in comparison with the case of irradiating the laser beams 11 onto the subject to be machined 37 in the bundle as described in the prior art, the laser beams 11 are not irradiated onto the unnecessary portion. Therefore, the portion not requiring the machining in the subject to be machined 37 is not damaged or chemically changed by the laser beams 11. Further, among the laser beams 11 irradiated onto the micro lens array 29, the rate of the laser beams 11 used for machining is increased, and an energy efficiency is improved.

Further, when the structure is made such as to convert the intensity distribution of the laser beams 11 by the intensity distribution converting optical part 25 so as to irradiate the laser beams 11, it is possible to irradiate a necessary amount of laser beams 11 onto the subject to be machined 37. Accordingly, for example, it is possible to machine all the machining areas 98 at a substantially even energy density, the machining condition becomes equal and the machining accuracy is improved.

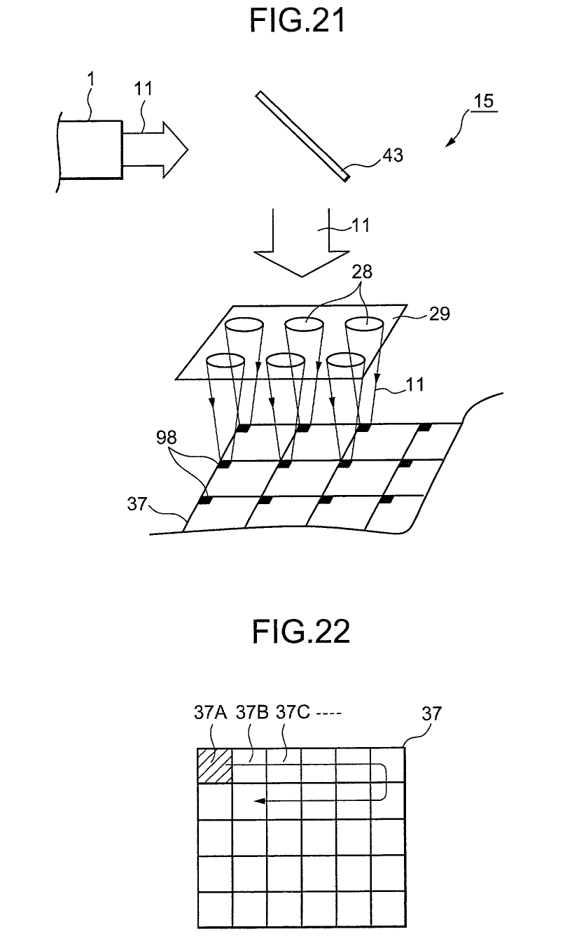

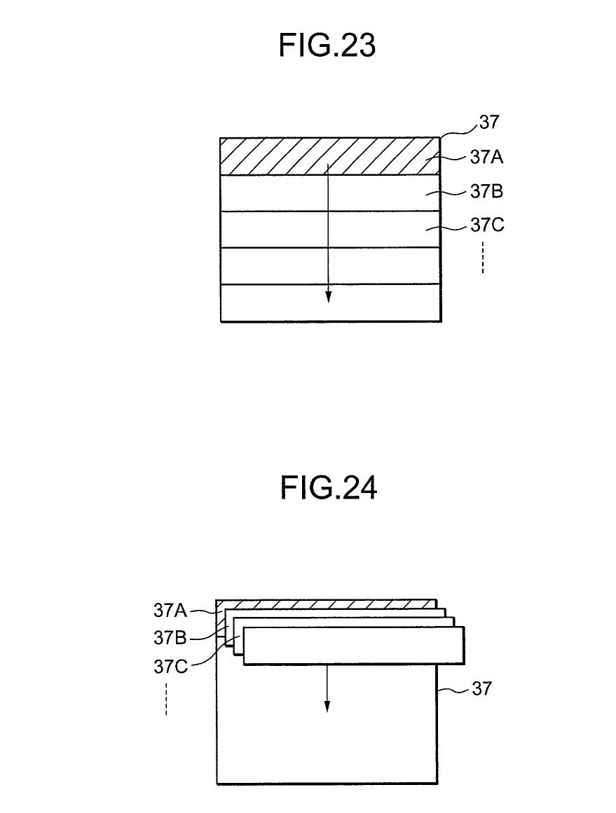

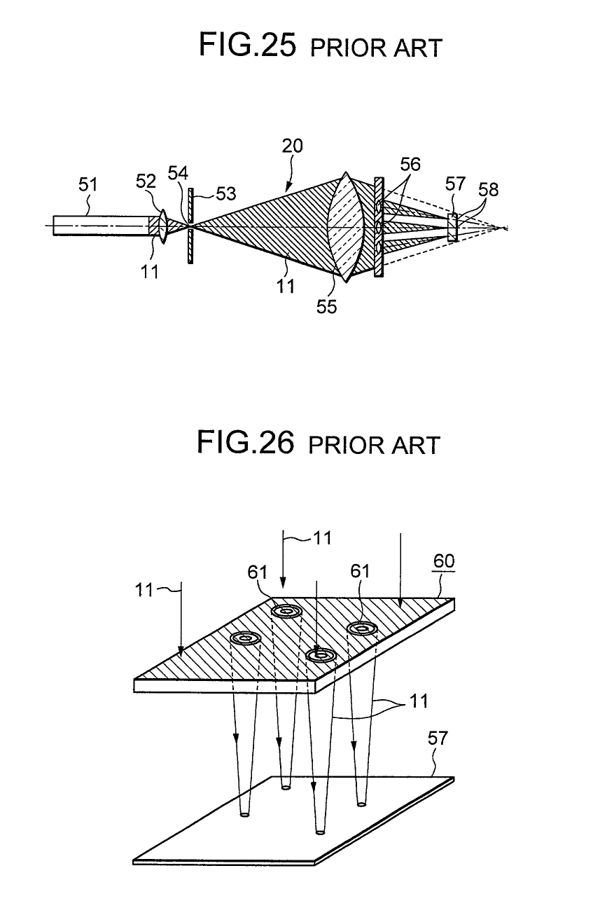

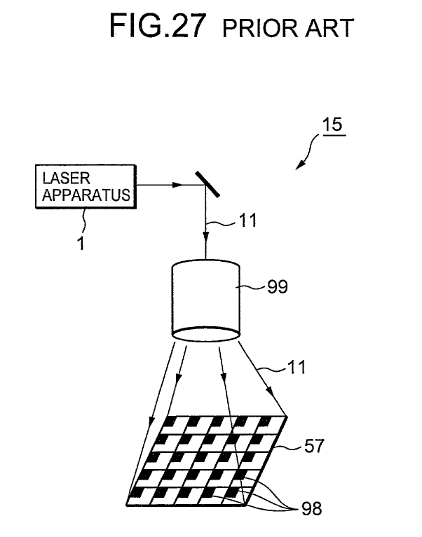

Further, in accordance with each of the embodiments mentioned above, the description is given of the case of irradiating the laser beams 11 onto the subject to be machined 37 in the bundle, however, the structure is not limited to this. As shown in FIG. 22, the structure is made such that the subject to be machined 37 may be irradiated at each of the machining areas 37A, 37B, 37C and the like separated in vertical and horizontal directions and may be irradiated while being scanned in a C-shaped manner. Further, as shown in FIG. 23, the subject to be machined may be separated in a narrow line manner, and each of the machining areas 37A, 37B, 37C and the like may be irradiated while being scanned in one direction.

Further, the structure may be made such as to irradiate while overlapping the irradiating areas 37A, 37B, 37C and the like as shown in FIG. 24. Accordingly, it is possible to reduce an uneven irradiation. In this case, FIG. 24 is described by slightly shifting the irradiating areas 37A, 37B, 37C and the like in a horizontal direction in order to make it easy to understand. As mentioned above, by separating the subject to be machined 37 so as to irradiate, it is possible to machine the subject to be machined 37 having a large area.

In this case, in each of the embodiments mentioned above, when the wavelength of the seed beams 48 is made narrow-band, only the seed beams 48 made narrow-band are amplified within the oscillator 50, and the laser beams 11 having a narrow spectrum width are emitted. Accordingly, since the condensing characteristic of the laser beams 11 is improved, it is possible to perform a finer machining.

Further, the seed laser oscillator 47 may employ a structure obtained by wavelength converting solid laser beams through a wavelength converting device in place of the excimer laser apparatus. Accordingly, since a parallel degree of the seed beams 48 is further improved and the spectrum width is narrowed, the parallel degree of the laser beams 11 emitted from the oscillator 50 is also improved and the spectrum width thereof is narrowed. Therefore, a condensing characteristic of the laser beams 11 is improved and it is possible to perform a finer machining.

Further, the description is given of the case that the laser gas containing F₂, Kr and Ne is charged within the laser chamber 2 and the ultraviolet rays laser apparatus is the KrF excimer laser, however, the structure is not limited to this, and for example, an ArF excimer laser may be employed. Further, the present invention is effective to all the ultraviolet rays lasers oscillating the ultraviolet rays laser beams such as the F₂ laser or the Like, not limited to the excimer laser.

What is claimed is:

1. A laser machining apparatus which irradiates laser beams onto a subject to be machined so as to perform a machining, comprising:
an ultraviolet rays laser apparatus having an unstable resonator; and
a condenser array having a plurality of condensers for irradiating said laser beams onto said subject to be machined.

2. A laser machining apparatus as claimed in claim 1, further comprising an intensity distribution converting optical part for converting an intensity distribution of the laser beams oscillated from said ultraviolet rays laser apparatus into an optional distribution.

3. A laser machining apparatus as claimed in claim 1 or 2, wherein said ultraviolet rays laser apparatus is an injection locking type laser apparatus.

4. A laser machining apparatus as claimed in claim 1 or 2, wherein the condensers of said condenser array are arranged one to one in correspondence to an arrangement of machining positions of said subject to be machined.

5. A laser machining apparatus as claimed in claim 1 or 2, wherein said condenser array is arranged so that the laser beams condensed by said respective condensers are respectively condensed on the surface of said subject to be machined.

6. A laser machining apparatus as claimed in claim 3, wherein the condensers of said condenser array are arranged one to one in correspondence to an arrangement of machining positions of said subject to be machined.

7. A laser machining apparatus as claimed in claim 3, wherein said condenser array is arranged so that the laser beams condensed by said respective condensers are respectively condensed on the surface of said subject to be machined.

8. A laser machining apparatus as claimed in claim 4, wherein said condenser array is arranged so that the laser beams condensed by said respective condensers are substantially condensed on the surface of said subject to be machined respectively.
